(19) United States
(12) Patent Application Publication
(10) Pub. No.: US 2005/0007508 A1
(43) Pub. Date: Jan. 13, 2005

(54) Display device having an improved through-hole connection

(76) Inventors: Kazunari Saitou, Mobara (JP); Haruhisa Iida, Chiba (JP); Iwao Takemoto, Mobara (JP); Katsumi Matsumoto, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/886,636

(22) Filed: Jul. 9, 2004

(30) Foreign Application Priority Data
Jul. 9, 2003 (JP) 2003-194124

(51) Int. Cl. G02F 1/1343

(52) U.S. Cl. 349/38

(57) ABSTRACT

A display device has plural pixel areas on the substrate. Each of the pixel areas has a pixel electrode and a multilevel structure disposed below the pixel electrode. The multilevel structure includes a first conductive layer, a first insulating film, a second conductive layer, a second insulating film, and a third conductive layer stacked in this order from the substrate. A solid electrical conductor is buried to fill a through-hole in the first insulating film to contact the first conductive layer, the second conductive layer is provided with a hole larger in diameter than the conductor, and the second insulating film is provided with a through-hole larger in diameter than the conductor, but smaller in diameter than the hole in the second conductive layer, and the third conductive layer is coated on the second insulating film to contact the conductor via the through-hole in the second insulating film.

The present application claims priority from Japanese application serial no. 2003-194124, filed on Jul. 9, 2003, the content of which is hereby incorporated by reference into this application.

### BACKGROUND OF THE INVENTION

The present invention relates to a panel display device, and for example, to a liquid crystal display device for use in a projector. Known among liquid crystal display devices used for projectors are reflective type liquid crystal display devices which use pixel electrodes of respective pixels for reflectors also.

A pixel electrode which doubles a reflector is formed for each of pixels on a liquid-crystal-layer-side surface of a first one of a pair of first and second substrates disposed to oppose each other with a liquid crystal layer interposed therebetween. An electric field is generated between the pixel electrode and a transparent counter electrode formed for all the pixels in common on a liquid-crystal-layer-side surface of the second transparent substrate so that the electric field controls the light transmission through the liquid crystal layer in each of the pixels independently of each other.

Light from a light source enters the second substrate, passes through the liquid crystal layer in each of the pixels, then is reflected by the pixel electrode, passes through the liquid crystal layer again, then passes through the second substrate, and then is projected onto a screen.

Here, the pixel electrode is made of opaque material, and therefore a capacitance element of a comparatively large capacitance can be formed between the pixel electrode and the first substrate. This capacitance element is provided to store a video signal supplied to the pixel electrode for a comparatively long period of time.

Consequently, a layer configuration made up of alternately stacked layers of conductive layers and insulating films is formed between the pixel electrode and the first substrate, and there arises a need for conductive layers of different layers to be electrically connected together via a through-hole. In this case, a first insulating film, a first conductive film, a second insulating film, a second conductive film, a third insulating film and a third conductive film are stacked successively, and there is sometimes a need for the first and third conductive films to be electrically connected together, and there arises a need for them to be electrically connected together via two concentric through-holes made in positions of the second and third insulating films, respectively, corresponding to a hole made in the second conductive film.

Conventionally, a configuration is known in which employs a conductive joint film electrically isolated from the second conductive film for electrically connecting the first and third conductive films, by fabricating the conductive joint film from the same material and in the same processing step as those of the second conductive film within the hole made in the second conductive film. Such a configuration is disclosed in Japanese Patent Laid-Open No. 2002-40482 publication, for example.

### SUMMARY OF THE INVENTION

In the above-described conventional technique, it was necessary that the conductive joint film covers the top surface of the second insulating film in the vicinity of the through-hole made in the second insulating film as well as the bottom of the through-hole (which exposes the first conductive film) and the side wall of the through-hole. This is because the third conductive film has to be connected to the conductive joint film via a through-hole made in the third insulating film underlying the third conductive film. Therefore, to secure a reliable electrical connection between the first and third conductive films, it was inevitable that a diameter of the conductive joint film concentric with the through-hole in the second insulating film is selected to be relatively large, and a problem arises in that an area required for the electrical connection becomes large because this prevents reduction in area of a pixel. It is often that the second conductive film doubles as one of electrodes of a capacitance element. Formation of a large hole in the connection point between the first and third conductive films makes it inevitable to decrease the capacitance of the capacitance element, and increasing of the capacitance of the capacitance element makes it inevitable to increase a pixel area (a pixel electrode).

In view of the above, it is an object of the present invention to provide a display device capable of reducing an area of a pixel.

The following explains briefly the summary of the representative ones of the present inventions.

The representative structures of the present invention are as follows:

In accordance with an embodiment of the present invention, there is provided a display device having a substrate and a plurality of pixel areas formed on said substrate, wherein each of said plurality of pixel areas comprises a pixel electrode and a multilevel structure disposed below said pixel electrode, wherein said multilevel structure comprises a first conductive layer, a first insulating film, a second conductive layer, a second insulating film, and a third conductive layer stacked in the order named from said substrate, wherein a solid electrical conductor is buried to fill a through-hole made in said first insulating film to contact said first conductive layer, wherein said second conductive layer is provided with a hole larger in diameter than said solid electrical conductor, and said second insulating film is provided with a through-hole larger in diameter than said solid electrical conductor, but smaller in diameter than said hole in said second conductive layer, and wherein said third conductive layer is coated on said second insulating film to contact said solid electrical conductor via said through-hole in said second insulating film.

The present invention is not limited to the above-described embodiments, and various changes and modifications can be made without departing from the spirit and scope of the present invention.

### BRIEF DESCRIPTION OF THE DRAWINGS

In the accompanying drawings, in which like reference numerals designate similar components throughout the figures, and in which:

FIG. 1 is a fragmentary perspective cross-sectional view of an embodiment of a display device in accordance with the present invention;

FIG. 2 is a plan view illustrating four adjacent ones of pixels arranged in a matrix fashion in an embodiment of a display device in accordance with the present invention;

FIG. 3 is a cross-sectional view of the embodiment of FIG. 2 taken along line III-III in FIG. 2; and

FIGS. 4(a) to 4(e) are cross-sectional views illustrating a sequence of steps for an example of a method forming the pixel of the embodiment of FIG. 3.

### DETAILED DESCRIPTION OF THE PREFERRED EMBODIMENTS

The following will explain an embodiment of a display device in accordance with the present invention by reference to the drawings.

In this embodiment, a reflective type liquid crystal display device is disclosed which is used for a projector. However, the present invention is also applicable to other flat display devices such as an organic electroluminescent display device.

First, a configuration of a reflective type liquid crystal display device will be explained.

In a liquid crystal display device of this type, a pixel electrode is formed in each of plural pixel areas arranged in a matrix fashion on a liquid-crystal-layer-side surface of a first one of a pair of first and second substrates disposed to oppose each other with a liquid crystal layer interposed therebetween. This pixel electrode is made of a conductive layer having a good reflectance. A counter electrode having a good light transmission is formed to face all the plural pixel areas in common on a liquid-crystal-layer-side surface of the second substrate.

Each of the pixel electrodes in the pixel areas is supplied with video signals independently of each other, while the counter electrode is supplied with a signal which serves as a reference voltage for the video signals. Electric fields are applied across the liquid crystal layer between the respective pixel electrodes and the counter electrode corresponding to voltage differences produced therebetween, and the light transmission through the liquid crystal layer is controlled based upon the strength of the electric fields.

Light from a light source enters the second substrate, passes through the liquid crystal layer, then is reflected by the pixel electrodes in the respective pixel areas formed on the first substrate, and then passes through the liquid crystal layer and the second substrate again, and an image produced by a collection of the pixels is projected onto a screen.

Further, the first substrate on which the pixel electrodes are formed is a semiconductor substrate made of Si, for example, a circuit for driving the liquid crystal display device is fabricated within this substrate, and this configuration makes it possible to make the liquid crystal display device itself. In this circuit configuration, a plurality of gate signal lines are formed each of which is associated with one of rows of pixels arranged in an x direction, for example, in a matrix fashion, each of the pixels is provided with a switching element to be switched ON by a scanning signal supplied to a corresponding one of the gate signal lines, and a plurality of drain signal lines are formed each of which supplies video signals to pixel electrodes in the respective pixels in a corresponding one of columns of pixels arranged in a y direction via the switching elements. This circuit configuration includes a scanning signal drive circuit for supplying a scanning signal to each of the gate signal lines and a video signal drive circuit for supplying video signals to respective ones of the drain signal lines. For the purpose of device construction and operation, U.S. patent application Ser. No. 09/908,856 is hereby incorporated by reference.

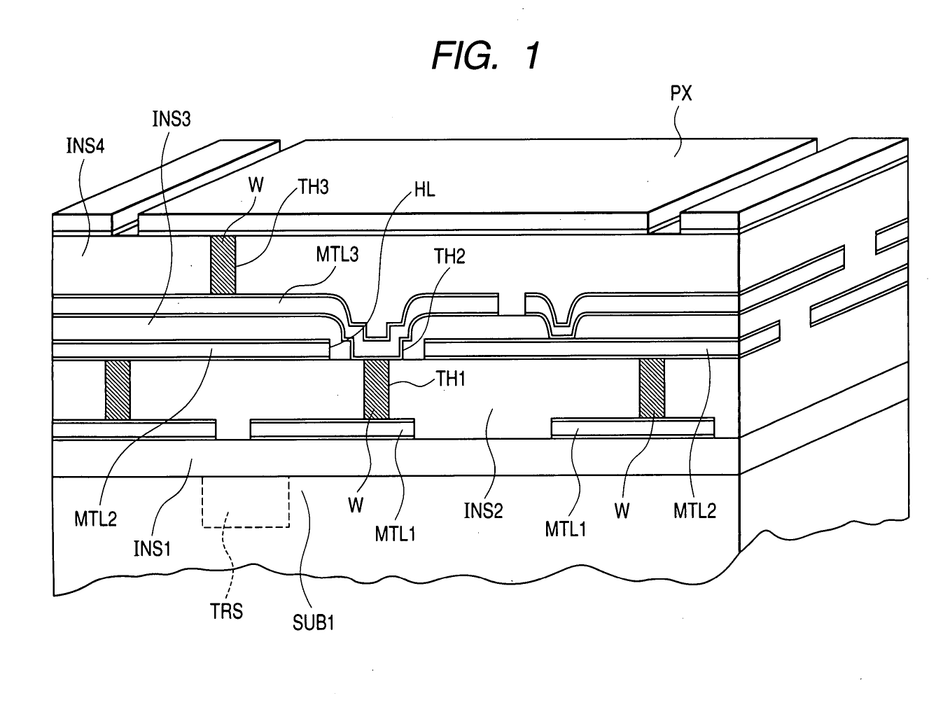

FIG. 1 is a fragmentary perspective cross-sectional view of a substrate SUB1 in accordance with an embodiment of the present invention, on which the above-explained pixel electrodes are formed. Formed on a surface of the semiconductor substrate SUB1 having incorporated therein the above-explained circuit are a first insulating film INS1 made of silicon oxide or the like, for example, and a stack (a multilevel structure) comprised of several alternate conductive and insulating films is formed on the top surface of the first insulating film INS1. A first metal layer MTL1 having a desired pattern is formed on the first insulating film INS1, is supplied with signals from the circuit fabricated within the substrate SUB1, and ultimately function as a conductive layer for transferring the signals pixel electrodes PX which will be explained subsequently.

For example, the first metal layer MTL1 is electrically connected to a source electrode of the above-explained switching element (TRS shown schematically by dashed lines in FIG. 1) fabricated within a portion of the semiconductor substrate SUB1 underlying the pixel.

Also formed on the first insulating film INS1 is a second insulating film INS2 which also covers the first metal layer MTL1, and a second metal layer MTL2 having a desired pattern is formed on the second insulating film INS2. The second metal layer MTL2 is electrically connected to the first metal layer MTL1 via a so-called plug W made of an electrical conductor buried in a through-hole TH1 made in the second insulating film INS2 for transferring the signals supplied to the first metal layer MTL1 to the second metal layer MTL2. Here, the phrase “an electrical conductor buried in a through-hole” as used in this specification refers to an electrical conductor solid all the way through, but not a hollow conductor formed of conductive layers coated on the bottom and side wall of the through-hole, which will not produce satisfactory results. It is preferable that a top surface of the solid conductor is flush with the top surface of the insulating film in which the through-hole is made.

The second metal layer MTL2 functions as an electrode forming a capacitance element in cooperation with a third metal layer MTL3 which will be explained later, for example, and the second metal layer MTL2 is formed to be large in area. This capacitance element is provided to a store video signal supplied to a pixel electrode PX which will be explained later. A hole HL is made in a portion of the second metal layer MTL2 where an electrical connection is to be made between the first metal layer MTL1 and the third metal layer MTL3 which will be explained later, and the hole HL is selected to be large enough in diameter to prevent occurrence of an electrical conduction in this connection area.

Formed on the top surface of the second insulating film INS2 is a third insulating film INS3 which also covers the second metal layer MTL2, and the third metal layer MTL3 having a desired pattern is formed on the third insulating film INS3. The third metal layer MTL3 is electrically connected at its portion to the second metal layer MTL2 via a through-hole made in the third insulating film INS3 for transferring signals supplied to the second metal layer MTL2 to the third metal layer MTL3.

Further, the third metal layer MTL3 is electrically connected at its portion to the first metal layer MTL1, and this electrical connection is made in a location where the hole HL is made in the second metal layer MTL2. In this location, the third metal layer MTL3 is formed on a surface of the second insulating film INS2 exposed within a through-hole TH2 made in the third insulating film INS3, and is electrically connected to the first metal layer MTL1 via the plug W made of an electrical conductor buried in the through-hole TH1 made in the second insulating film INS2 at approximately the center of the surface of the second insulating film INS2 exposed within the through-hole TH2. With this configuration, the signals supplied to the first metal layer MTL1 can be transferred to the third metal layer MTL3.

Here, the third metal layer MTL3 is formed to overlap the second metal layer MTL2 to a comparatively large extent so as to serve as one electrode of the above-explained capacitance element formed in cooperation with the second metal layer MTL2 using the third insulating film INS3 as its dielectric film.

Formed on the top surface of the third insulating film INS3 is a fourth insulating film INS4 which also covers the third metal layer MTL3, and the pixel electrode PX is formed on the surface of the fourth insulating film INS4. The pixel electrode PX is made of a metal layer having a good light reflectance as described above. The pixel electrode PX is electrically connected to the third metal layer MTL3 via a plug W made of an electrical conductor buried in a through-hole TH3 made in the fourth insulating film INS4. With this configuration, the signals supplied to the third metal layer MTL3 can be transferred to the pixel electrode PX.

Here, formed on the surface of the thus configured semiconductor substrate SUB1 is an liquid-crystal-molecule-orientation film (not shown) which also covers the pixel electrode PX. This orientation film is in direct contact with a liquid crystal layer, and establishes a direction of an initial orientation of molecules of the liquid crystal layer.

This semiconductor substrate SUB1 is disposed to face a transparent substrate with the liquid crystal layer interposed therebetween, an electric field is generated between the pixel electrode PX and a counter electrode made of transparent electroconductive material and formed on a liquid-crystal-layer-side surface of the transparent substrate so as to control a light transmission through the liquid crystal layer.

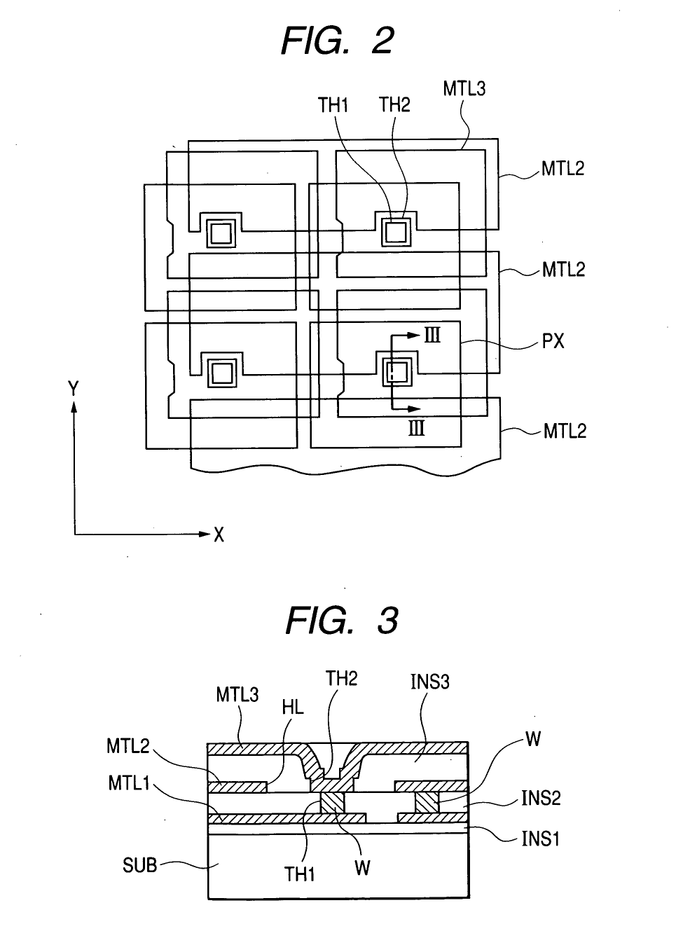

FIG. 2 is a plan view illustrating four adjacent ones of pixels arranged in a matrix fashion. FIG. 2 illustrates a positional relationship among the second metal layer MTL2, the third metal layer MTL3, the pixel electrode PX, the through holes TH1, TH2, with the first metal layer MTL1 being omitted for clarity.

As described above, in the electrical connection point between the first metal layer MTL1 and the third metal layer MTL3, the hole HL is made for the second metal layer MT2 to get clear of the electrical connection, and the dimension of one side of the hole HL can be selected to be about 1.7 μm. At approximately the center of the area of 1.7 μm×1.7 μm, the central axis of the through-hole TH2 in the third insulating film INS3 is made approximately coincident with that of the through-hole TH1 in the second insulating film INS2.

In this case, while the area of the pixel electrode PX is 8.1 μm×8.1 μm, for example, the area of the hole HL made in the second metal layer MTL2 is 1.7 μm×1.7 μm, and consequently, the area occupied by the hole HL, that is, the connection point between the first metal layer MTL1 and the third metal layer MTL3, is greatly reduced.

Here, in FIG. 2, the two second metal layers MTL2 associated with two adjacent pixels in an x direction, respectively, are connected together, but the two second metal layers MTL2 associated with two adjacent pixels in a y direction, respectively, are isolated from each other. This is because the electrodes of the capacitance elements are formed as signal lines. The hole HL made in the second metal layer MTL2 is formed to straddle the isolating area.

FIG. 3 is a cross-sectional view of the embodiment of FIG. 2 taken along line III-III in FIG. 2. For simplicity, the fourth insulating film INS4 and the pixel electrode PX have been omitted.

Incidentally, as in the conventional technique, in a case where a conductive joint film was formed to be electrically isolated from the second metal layer MTL2, but to be electrically connected to the first metal layer MTL1 via the through-hole TH1 made in the second insulating film INS2, in the same fabrication step as that for the second metal layer MTL2, and then the third metal layer MTL3 was electrically connected to the conductive joint film via the through-hole TH2 made in the third insulating film INS3, an area of the hole required for the conductive joint film to be electrically isolated from the second metal layer MTL2 was 3.1 μm×3.1 μm, where the respective through-holes are disposed in the hole with their central axes coincident with each other.

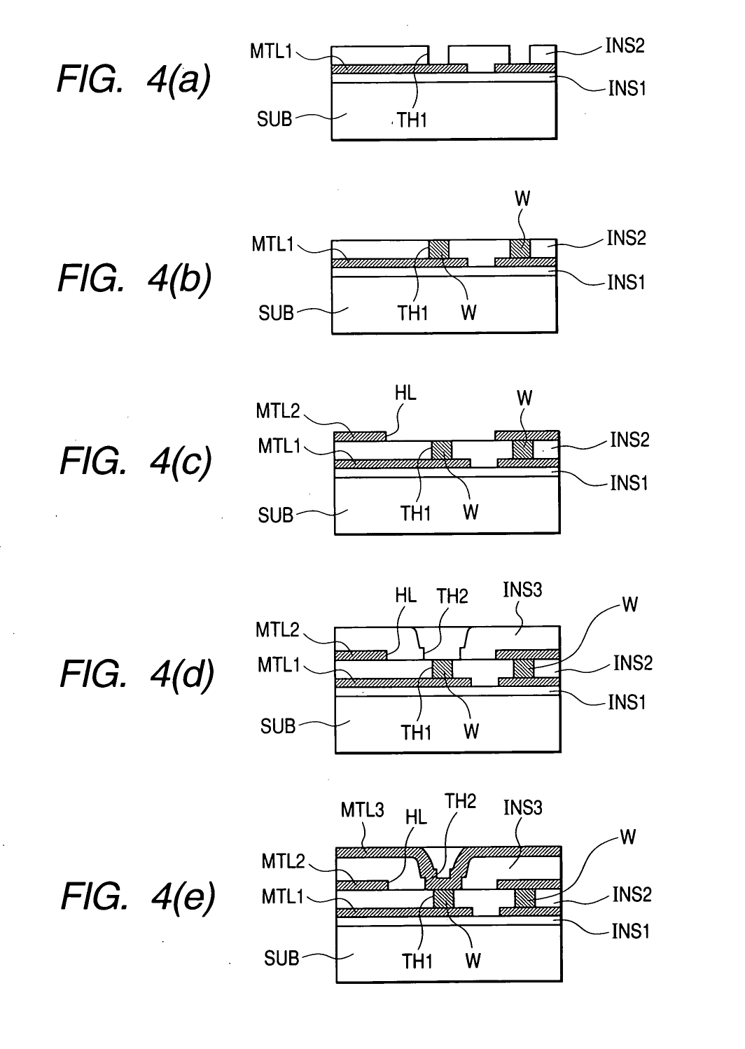

FIGS. 4(a) to 4(e) are cross-sectional views illustrating a sequence of steps for an example of a method fabricating the portion of the pixel illustrated in FIG. 3. The following will explain the sequence of steps.

Process Step 1 (FIG. 4(a))

The first metal layer MTL1 (aluminum film of 600 nm in thickness formed by sputtering, for example) having a desired pattern is formed on a surface of the first insulating film INS1 (film made of BPSG (borophosphosilicate glass), for example) fabricated on a surface of the substrate SUB (Si substrate, for example). Then the second insulating film INS2 (silicon dioxide film of 1000 nm in thickness formed by using TEOS (tetraethylorthosilicate), for example) is formed on a surface of the first insulating film INS1 such that the first metal layer MTL1 is also covered with the second insulating film INS2. Then the through-holes TH1 are made at specified locations of the second insulating film INS2 by using a plasma etching, for example, so as to expose portions of the first metal layer MTL1. In this case, it is preferable that the through-holes TH1 are to be selected to be about 0.5 μm in diameter.

Process Step 2 (FIG. 4(b))

The plugs W are fabricated in the form of solid conductors by burying conductive material in the through-holes TH1 in the second insulating film INS2. The solid conductors can be fabricated by depositing tungsten (W) using a CVD (Chemical Vapor Deposition) method using WF₆, H₂ and SiH₄ gases, for example, and then by etching excess deposits off using an etching gas.

Process Step 3 (FIG. 4(c))

The second metal layer MTL2 (aluminum film of 300 nm in thickness formed by sputtering, for example) having a specified pattern is formed by etching on the second insulating film INS2. Then the hole HL is made in the second metal layer MTL2 such that one of the plugs W is exposed at the center of the hole HL. It is preferable that the hole HL is selected to be about 0.9 μm in diameter.

Process Step 4 (FIG. 4(d))

The third insulating film INS3 (silicon dioxide film of 300 nm in thickness formed by using TEOS, for example) is formed on the second metal layer MTL2, the second insulating film INS2 and the plug W, and then the through-hole TH2 (0.7 μm in diameter, for example) is made in the third insulating film INS3 so as to expose the plug W.

Process Step 5 (FIG. 4(e))

The third metal layer MTL3 is formed on the surface of the third insulating film INS3 covering the through-hole TH2, and then is patterned into a specified shape. Within the through-hole TH2, the third metal layer MTL3 (aluminum film of 300 nm in thickness formed by sputtering, for example) is formed such that it coats the bottom and the side wall of the through-hole TH2 and at the same time is electrically connected to the plug W buried in the second insulating film INS2 at the bottom of the through-hole TH2.

Incidentally, in FIG. 1, byway of example, the fourth insulating film INS4 is a silicon dioxide film of 800 nm in thickness formed by using TEOS, for example, the diameter of the through-hole TH3 made in the fourth insulating film INS4 is 0.7 μm, and the pixel electrode PX is an aluminum film of 200 nm in thickness formed by sputtering.

The above embodiment has been explained by using a liquid crystal display device as an example, and the present invention is also applicable to other display devices such as an organic EL (Electroluminescent) display device. In such display devices, there are cases where first, second and third conductive layers are stacked in this order with insulating films interposed therebetween in a pixel area on a substrate, and where an electrical connection is made between the first and third conductive layers via a hole made in the second conductive layer.

As is obvious from the above explanation, the display device in accordance with the present invention is capable of reducing its pixel in area.

1. A display device having a substrate and a plurality of pixel areas formed on said substrate,
wherein each of said plurality of pixel areas comprises a pixel electrode and a multilevel structure disposed below said pixel electrode,
wherein said multilevel structure comprises a first conductive layer, a first insulating film, a second conductive layer, a second insulating film, and a third conductive layer stacked in the order named from said substrate,
wherein a solid electrical conductor is buried to fill a through-hole made in said first insulating film to contact said first conductive layer,
wherein said second conductive layer is provided with a hole larger in diameter than said solid electrical conductor, and said second insulating film is provided with a through-hole larger in diameter than said solid electrical conductor, but smaller in diameter than said hole in said second conductive layer, and
wherein said third conductive layer is coated on said second insulating film to contact said solid electrical conductor via said through-hole in said second insulating film.

2. A display device according to claim 1, wherein said solid electrical conductor is comprised of one of tungsten and aluminum deposited by using a chemical vapor deposition method.

3. A display device according to claim 2, wherein said third conductive layer comprised of sputtered aluminum.

4. A display device according to claim 1, wherein said second conductive layer serves as one of electrodes forming a capacitance element for storing a video signal supplied to said pixel electrode.

5. A display device according to claim 1, wherein said pixel electrode is disposed above said multilevel structure with an insulating film interposed therebetween, and is comprised of material having good light reflectance.

6. A display device according to claim 1, wherein said substrate is comprised of a semiconductor material.

7. A display device according to claim 1, wherein central axes of said through-hole made in said first insulating film, said hole made in said second conducting layer and said through-hole made in said second insulating film are approximately coincident with each other.
